(19) United States
(12) Patent Application Publication
(10) Pub. No.: US 2017/0098098 A1
(43) Pub. Date: Apr. 6, 2017

(54) SECURE IMAGES

(71) Applicants: Zhen XIAO, Beijing (CN); EMPIRE TECHNOLOGY DEVELOPMENT LLC, WILMINGTON (DE)

(72) Inventor: Zhen XIAO, Beijing (CN)

(73) Assignee: EMPIRE TECHNOLOGY DEVELOPMENT LLC, WILMINGTON, DE (US)

(21) Appl. No.: 15/312,203

(22) PCT Filed: May 27, 2014
(86) PCT No.: PCT/CN2014/078517

§ 371 Date: Nov. 18, 2016

(51) Int. Cl. G06F 21/62; G06F 21/84

(52) U.S. Cl. CPC G06F 21/6245; G06F 21/84; G06F 2221/032

(57) ABSTRACT

When confidential information is displayed at a display device, a secure image may be generated so that the confidential information is visible only to an authorized user within a predetermined viewing distance. In some examples, incorrect information may be generated to mislead an unauthorized viewer outside the predetermined viewing distance.

### TECHNICAL FIELD

The technologies described herein pertain generally to generating a secure image to prevent confidential information being revealed to an unauthorized viewer.

### BACKGROUND

Unless otherwise indicated herein, the approaches described in this section are not prior art to the claims in this application and are not admitted to be prior art by inclusion in this section.

When confidential information is displayed on or by a display device for viewing by an authorized user who is close to the display device, one or more unauthorized viewers may also be able to see the displayed confidential information as well.

### SUMMARY

Technologies are generally described to generate secure images. The various techniques described herein may be implemented in various methods, systems, computer-readable mediums, and/or computer programmable products.

In some examples, various embodiments may be implemented as methods. Some methods may include providing an initial image file that includes first and second graphics superimposed over a background graphic, wherein the initial image file includes image data associated with non-overlapping portions of the first and second graphics; and generating a secure image for display on the display device by identifying the non-overlapping portions of the image data, wherein the non-overlapping portions of the image data are associated with either the first graphic or the second graphic; replacing the non-overlapping portions of the image data associated with the first graphic with a first set of graphic patterns that are visually distinguishable from the background graphic within a predetermined viewing distance of the display device; and replacing the non-overlapping portions of the image data associated with the second graphic with a second set of graphic patterns that are visually indistinguishable from the background graphic outside of the predetermined distance of the display device.

In some examples, various embodiments may be implemented as systems. Some systems may include a cloud based server configured to generate image data associated with an initial image file that includes first and second graphics superimposed over a background graphic, wherein the image data includes non-overlapping portions of the first and second graphics, and transmit the image data via a network; and a display controller configured to detect a secured environment, receive the image data associated with the initial image file via the network, and generate a secure image for display on the display device by identifying the non-overlapping portions of the image data, wherein the non-overlapping portions of the image data are associated with either the first graphic or the second graphic, replacing the non-overlapping portion of the image data associated with the first graphic with a first set of graphic patterns that are visually distinguishable from the background graphic within a predetermined viewing distance of the display device, and replacing the non-overlapping portions of the image data associated with the second graphic with a second set of graphic patterns that are visually indistinguishable from the background graphic outside of the predetermined distance of the display device.

In some examples, various embodiments may be implemented as computer-readable mediums having executable instructions stored thereon. Some computer-readable mediums may store instructions that, when executed, cause one or more processors to perform operations comprising providing an initial image file that includes first and second graphics superimposed on a background graphic, wherein the initial image file includes image data associated with non-overlapping portions of the first and second graphics; and generating a secure image for display on the display device by identifying the non-overlapping portions of the image data, wherein the non-overlapping portions of the image data are associated with either the first graphics or the second graphics; identifying overlapping portions of the first and second graphics; replacing the non-overlapping portions of the image data associated with the first graphics with a first set of graphic patterns that are visually distinguishable from the background graphic within a predetermined viewing distance of the display device; replacing the non-overlapping portions of the image data associated with the second graphics with a second set of graphic patterns that are virtually indistinguishable from the background graphic outside of the predetermined viewing distance of the display device; and replacing the overlapping portions of the image data with a third set of graphic patterns.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example environment in which secure images may be generated and viewed;

FIG. 2 shows an example system by which secure images may be generated and viewed;

FIG. 3 shows an example of a secure image;

FIG. 4 shows an example configuration of a processing flow of operations by which secure images may be generated and viewed; and

FIG. 5 shows a block diagram illustrating an example computing device that is arranged to generate secure images, all arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

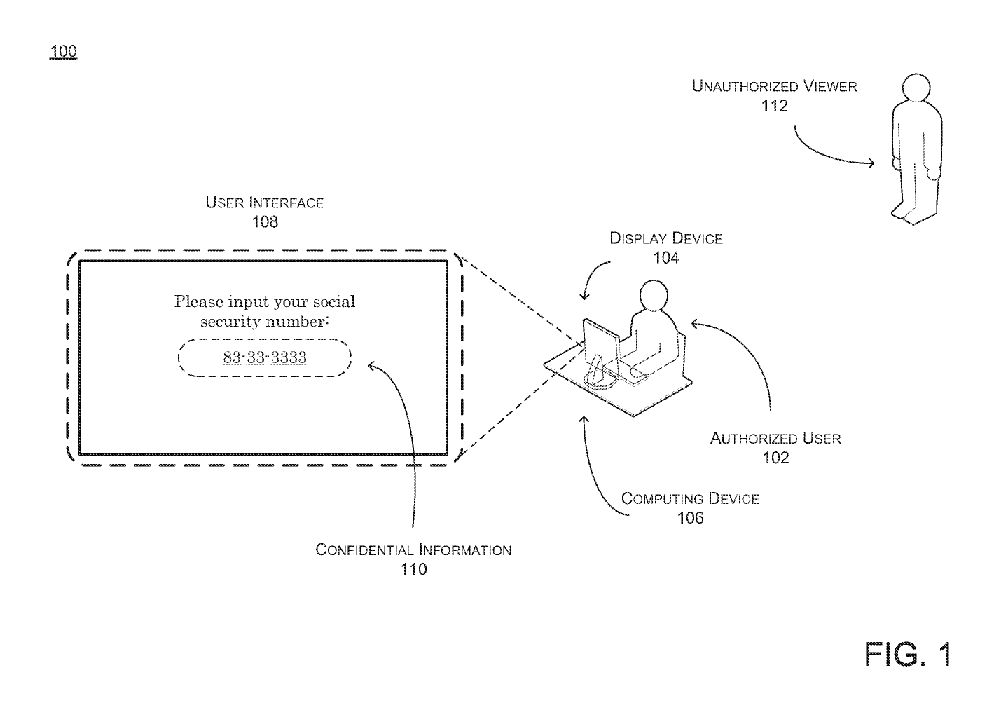

FIG. 1 shows an example environment 100 in which secure images may be generated and viewed, arranged in accordance with at least some embodiments described herein. As depicted, example environment 100 may include, at least, an authorized user 102, a display device 104, a computing device 106, a displayed user interface 108 that includes confidential information 110, and an unauthorized viewer 112.

Authorized user 102 may refer to a person who is authorized to access confidential information that is stored on a local computing device or an online data storage, and/or a person who possesses the confidential information and may provide instructions for display device 104 to display the confidential information, e.g., a user who enters a password on display device 104. Typically, authorized user 102 may be located relatively close to display device 104, e.g., within arm's reach of authorized user 102. As non-limiting examples, display device 104 may be implemented as a computer monitor, and therefore authorized user 102 may be located within arm's reach of display device 104; or display device 104 may be implemented as a smartphone, laptop computer, or a tablet computing device, and therefore authorized user 102 may physically hold display device 104.

Display device 104 may refer to a device configured to display information and/or images in response to instructions from authorized user 102, via computing device 106. Non-limiting examples of display device 104 may include segment displays, 2-dimensional displays (e.g., cathode ray tube display (CRT), light-emitting diode display (LED), liquid crystal display (LCD)), three dimensional (3D) display, etc. In some other examples, display device 104 may refer to a component or module of a device that integrates the above-identified non-limiting examples with computing device 106, such as smartphones, tablets, and/or laptops.

Computing device 106 may refer to a client device configured to receive confidential information and/or transmit the received confidential information to display device 104 for visual presentation. The confidential information may be input by authorized user 102 via an input device or retrieved by computing device 106 from an online data storage.

User interface 108 may refer to an interface that may be displayed on display device and is configured to present information and/or images to authorized user 102. Further, user interface 108 may be configured to the display information in response to the input of the authorized user 102. For example, user interface 108 may include a data input field in which authorized user 102 is requested to input his or her social security number and to further display the input social security number.

Confidential information 110 may refer to visual information displayed on user interface 108, which should not be accessible to unauthorized viewer 112. Thus, confidential information 110 may be regarded as any information, confidential or private in nature, which authorized user 102 intends or desires to view in a private and secure manner. In some examples, confidential information 110 may include the information previously stored on computing device 106 or on other devices communicatively coupled to computing device 106, e.g., a contract stored on the local hard drive of computing device 106 or a portable flash drive. In some other examples, confidential information 110 may include information input by authorized user 102, e.g., social security number, an answer to a security question, a password, a login username input.

Unauthorized viewer 112 may refer to a person that is not authorized to access and/or view confidential information 110. However, when confidential information 110 is displayed on display device 104, unauthorized viewer 112 may still peek at display device 104 at a distance. Examples of such unauthorized viewer 112 may include one or more fellow passengers on a subway, train, or airplane who peer over the shoulder of authorized user 102 to view confidential or otherwise private information displayed on display device 104; other attendees in a waiting lounge environment who cast uninvited glances at a display device 104 (e.g., laptop computer or tablet compute utilized by authorized user 102, to view the displayed confidential or otherwise private information; or colleagues or even strangers who walk by an office cubicle occupied by authorized user 102 and intentionally or unintentionally look to display device 104 (e.g., display monitor) to vie the displayed confidential or otherwise private information. Thus, computing device 106 may be configured to generate secure images that include confidential information 110 so that confidential information 110 may be invisible to unauthorized viewer 112.

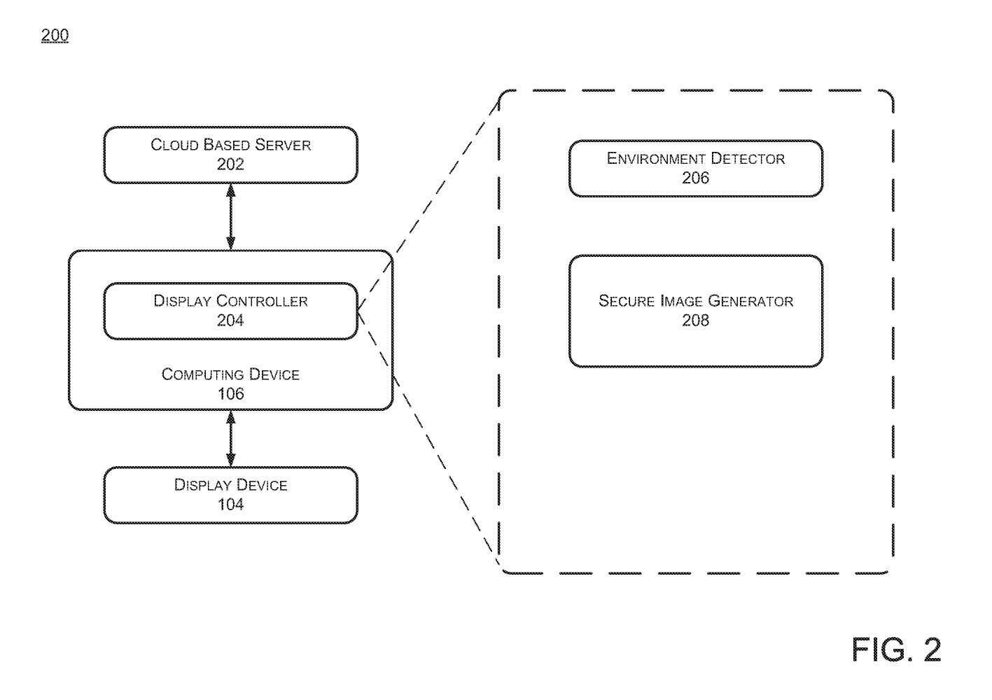

FIG. 2 shows an example system 200 by which secure images may be generated and viewed, arranged in accordance with at least some embodiments described herein. As depicted, example system 200 may include, at least, a cloud based server 202, a display controller integrated in computing device 106 that communicatively coupled to display device 104, an environment detector 206, and a secure image generator 208. Various embodiments of example system 200 may be implemented as hardware, software, firmware, or a combination thereof.

Cloud based server 202 may refer to one of multiple computers communicatively connected to computing device 106 through a communication network. Non-limiting examples of the communication network may include local area network (LAN), wide area network (WAN), internet, etc. In at least some example embodiments, cloud based server 202 may be configured to generate confidential information 110, which may be in a form of an initial image file that includes image data. The image data of the initial image file may include first and second graphics superimposed over a background graphic. The first and second graphics may refer to letters, characters, numbers, etc. In some other examples, however, the image data may be locally generated by computing device 106.

Display controller 204 may refer to a component of computing device 106 that may be configured to generate a secure image based on the first and second graphics, and to further transmit the secure image to display device 104. Display controller 204 may include environment detector 206 and secure image generator 208

Environment detector 206 may refer to a component of display controller 204 that may be configured to detect a secured environment, in which a heightened level of security may be appreciated. For example, a secured environment may be detected when authorized user 102 attempts to access a classified document or when an interface that prompts authorized user 102 to input confidential information is initiated. Non-limiting examples of such a detected secured environment may include authorized user 102 viewing a confidential document on display device 104, authorized user 102 inputting confidential information via interface 108 on display device 104, etc. Further to the examples, when authorized user 102 opens a document marked as confidential, environment detector 206 may detect the secured environment and secure image generator 208 may be configured to generate the secure image accordingly.

Secure image generator 208 may refer to a component of display controller 204 that may be configured to generate the secure image that includes confidential information 110 visible to authorized user 102 and misleading information visible to unauthorized viewer 112. In at least one example, the misleading information may be illustrated or indicated by the first graphic included in the initial image file that are superimposed on the background graphic. In some examples, secure image generator 208 may be configured to first identify non-overlapping portions of image data of confidential information 110. The non-overlapping portions may be associated with either the first graphic or the second graphic. Secure image generator 208 may be further configured to replace the non-overlapping portions of the image data associated with the first graphic with a first set of graphic patterns, e.g., stripes that may be visually distinguishable from the background graphic that is disposed at any viewing distance of display device 104.

In at least one example, the first set of graphic patterns may refer to multiple stripes that are disposed or displayed at a first spatial frequency that is greater than a threshold frequency and with a first contrast ratio that is greater than a threshold contrast ratio, so that the first graphic displayed on display device 104 may be visible to both authorized user 102 and unauthorized viewer 112. Thus, the first graphic may exclude confidential information 110 and further, in at least one example, the first graphic may include letters, characters, and/or numbers that are intentionally misleading to unauthorized viewer 112, e.g., wrong passwords.

Spatial frequency may refer to the frequency that a graphic pattern repeats per unit of distance, e.g., the width of the stripes changes horizontally. Non-limiting examples of the graphic pattern may include any type of repeated graphics, such as arrays of dots, circles, and bands. When the graphic pattern refers to dark and bright hands, the spatial frequency may refer to the reciprocal of the distance between the centers of adjacent dark (or bright) bands.

Contrast ratio may refer to a ratio of a luminance of the brightest color to that of the darkest color of the respective graphic patterns, e.g., a ratio of the luminance of the bright stripes to the luminance of the dark stripes. The threshold frequency and the threshold contrast ratio may be determined in accordance with existing research with respect to human eyes and the predetermined viewing distance. For example, the first graphic may be visible to unauthorized viewer 112 ten meters away if the spatial frequency is greater than a threshold frequency, e.g., 1/0.01 mm, and the contrast ratio is greater than 1000:1.

Secure image generator 208 may be further configured to replace the non-overlapping portions of the image data associated with the second graphic with a second set of graphic patterns that are visually indistinguishable from the background graphic outside of the predetermined viewing distance of display device 104. The second net of graphic patterns may refer to multiple stripes disposed or displayed at a second spatial frequency that is less than the threshold frequency and with a second contrast ratio that is less than the threshold contrast ratio so that the second graphic may not visible to unauthorized viewer 112. The second graphic may comprise confidential information 110. In some examples, secure image generator 208 may be configured to replace the overlapping portions of the image data with a third set of graphic patterns at a third spatial frequency and at a third contrast ratio. The third spatial frequency may or may not be the same as either the first or the second spatial frequency, and the third contrast ratio may or may not be the same as either the first or the second contrast ratio. In other examples, the third set of graphic patterns may refer to the combination of the first set and the second set of graphic patterns.

Thus, FIG. 2 shows an example system configured to generate a secure image based on confidential information 110 so that confidential information 110 may be invisible to unauthorized viewer 112 beyond the predetermined viewing distance.

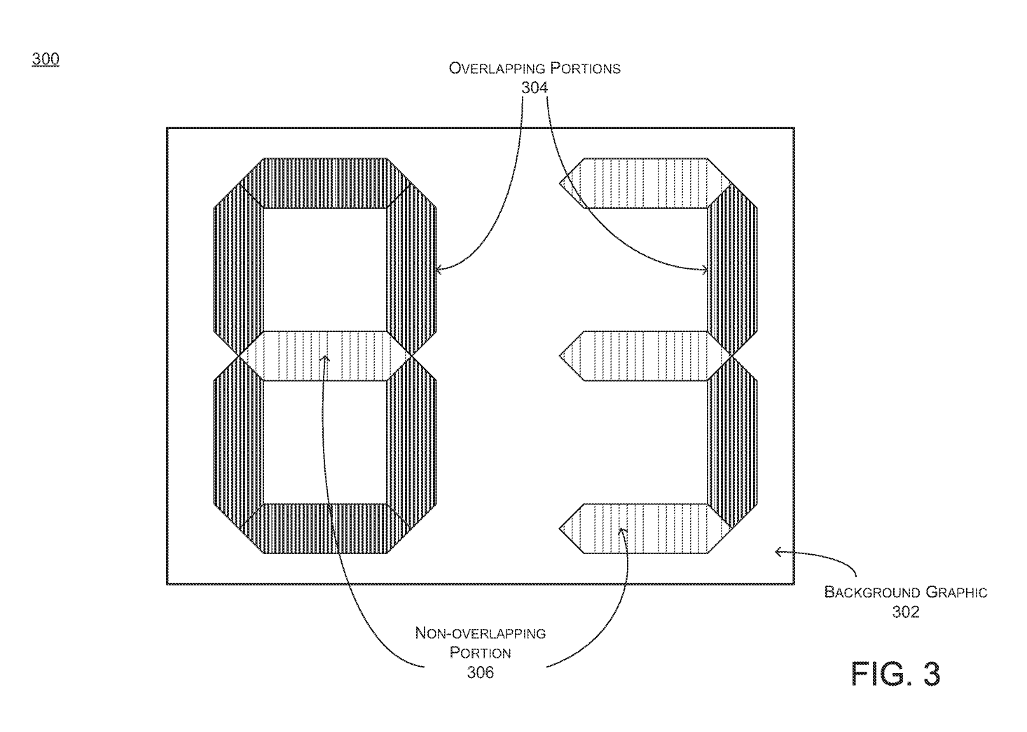

FIG. 3 shows an example of a secure image 300, arranged in accordance with at least some embodiments described herein. As depicted, example security image 300 may be generated by secure image generator 208 and displayed on display device 104 and may further include, at least, a background graphic 302, multiple overlapping portions 304, and multiple non-overlapping portions 306.

Background graphic 302 may refer to a portion of the image data that may be visually distinguishable to the first and second graphics to authorized user 102. As a part of the initial image file, background graphic 302 may be generated by cloud based server 202 or computing device 106. In some examples, background graphic 302 may be blank.

Overlapping portions 304 may refer to the overlapping portions of the first and second graphics initially generated by cloud based server 202 or computing device 102. For example, when the first graphic illustrates two numbers, “0” and “1,” and the second graphic illustrates two numbers “8” and “3,” overlapping portions 304 may refer to the overlapping portions of the numbers “8” and “0” and the overlapping portions of the numbers “3” and “1.” As depicted, overlapping portions 304 of the first and the second graphics may be replaced with the first set of graphic patterns, e.g., stripes, which may be visually distinguishable from background graphic 302 within and beyond the predetermined viewing distance of display device 104. In at least one example, the first set of graphic patterns may refer to multiple stripes at the first spatial frequency that is greater than the threshold frequency and with the first contrast ratio that is greater than the threshold contrast ratio, so that the first graphic may be visible to both authorized user 102 and unauthorized viewer 112. That is, unauthorized viewer 112 may see “0” and “1” at display device 104 outside the predetermined viewing distance.

Non-overlapping portions 306 may refer to the non-overlapping portions of the first and second graphics, e.g., the non-overlapping portions of figure “8” and “0.” As depicted, non-overlapping portions 306 may be replaced with a second set of graphic patterns that may be visually indistinguishable from background graphic 302 outside of the predetermined viewing distance of display device 104. The second set of graphic patterns may refer to multiple stripes at the second spatial frequency that is less than the threshold frequency and with the second contrast ratio that is less than the threshold contrast ratio so that the second graphic may not visible to unauthorized viewer 112. Thus, authorized user 102 may be the person properly positioned to view confidential information 110, e.g., “8” and “3,” on display device 104 within the predetermined viewing distance.

Thus, FIG. 3 shows an example secure image that provides confidential information 110 to authorized user 102 within a predetermined viewing distance and misleading information to unauthorized viewer 112 at any distance.

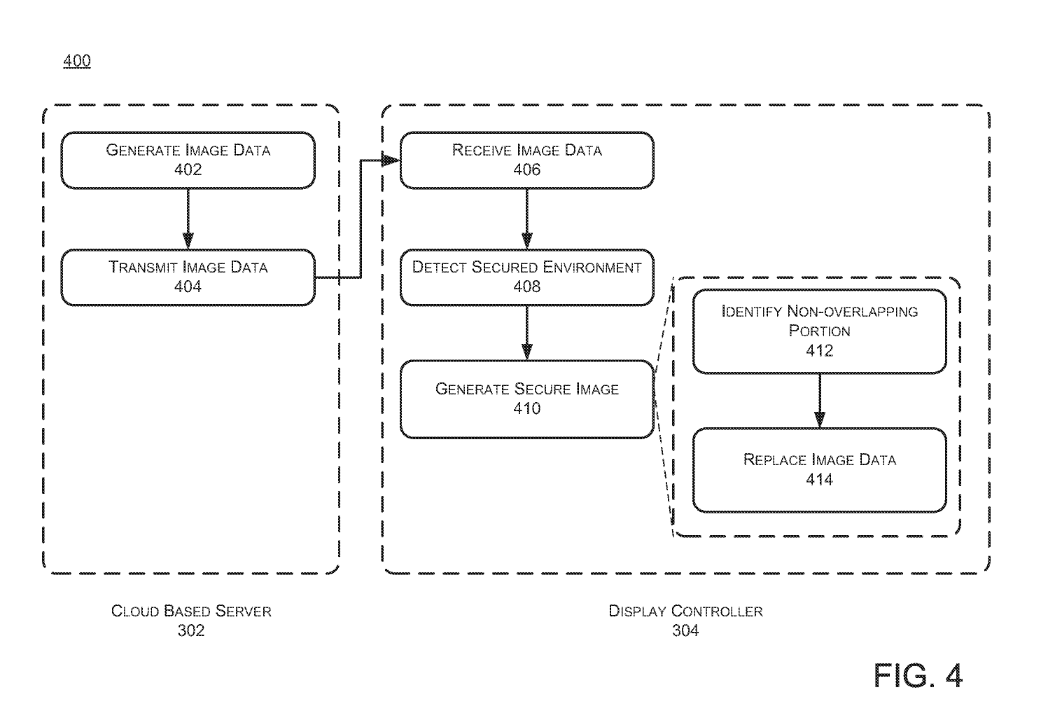

FIG. 4 shows an example configuration of a processing flow of operations by which secure images may be generated and viewed, arranged in accordance with at least some embodiments described herein. As depicted, processing flow 400 may include sub-processes executed by various components that are part of example systems 100 and 200. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 400 may include various operations, functions, or actions as illustrated by one or more of blocks 402, 404, 406, 408, 410, 412, and/or 414. Processing may begin at block 402.

Block 402 (Generate Image Data) may refer to cloud based server 302 or computing device 106 generating confidential information 110, which may be in a form n initial image file that includes image data. The image data of the initial image file may include the first and second graphics superimposed over a background graphic. The first and second graphics may refer to letters, characters, numbers, etc. Block 402 may be followed by block 404 or block 408.

Block 404 (Transmit Image Data) may refer to cloud based server 302 transmitting the image data of the initial image file via a communication network to computing device 106. Block 404 may be followed by block 406.

Block 406 (Receive Image Data) ay refer to computing device 106 receiving the image data via the communication network from cloud based server 302. Block 406 may be followed by block 408.

Block 408 (Detect Secured Environment) may refer to environment detector 206 detecting a secured environment, in which a heightened level of security may be appreciated. For example, a secured environment may be detected when authorized user 102 attempts to access a classified document or when an interface that prompts authorized user 102 to input confidential information is initiated. Non-limiting examples of the secured environment may include authorized user 102 viewing a confidential document, authorized user 102 inputting confidential information, etc. For example, when authorized user 102 opens a document marked as confidential, environment detector 206 may detect the secured environment. Block 408 may be followed by block 410.

Block 410 (Generate Secure Image) may refer to secure image generator 208 generating the secure image that includes confidential information 110 visible to authorized user 102 and misleading information visible to unauthorized viewer 112. In at least one example, the misleading information may be illustrated or indicated by the first graphic included in the initial image file that are superimposed on the background graphic. In some examples, secure image generator 208 may be configured to first identify non-overlapping portions of image data of confidential information 110. The non-overlapping portions may be associated with either the first graphic or the second graphic. Secure image generator 208 may be configured to replace the non-overlapping portions of the image data associated with the first graphic with a first set of graphic patterns, e.g., stripes that may be visually distinguishable from the background graphic that is disposed at any viewing distance of display device 104. Further, secure image generator 208 may be configured to replace the non-overlapping portions of the image data associated with the second graphic with a second set of graphic patterns that are visually indistinguishable from the background graphic outside of the predetermined viewing distance of display device 104. Thus, a secure image is generated based on confidential information 110 so that confidential information 110 may be invisible to unauthorized viewer 112 beyond the predetermined viewing distance. Block 410 may include block 412 and block 414.

Block 412 (Identify Non-overlapping Portions) may refer to secure image generator 208 identifying non-overlapping portions 306 of the first and second graphics of the image data e.g., the non-overlapping portions of figure “8” and “0.” Non-overlapping portions 306 of the image data may be associated with either the first graphic or the second graphic. The identifying may be performed in accordance with currently existing algorithms. Block 412 may be followed by block 414.

Block 414 (Replace Image Data) may refer to secure image generator 208 replacing the non-overlapping portions of the image data associated with the first graphic with a first set of graphic patterns, e.g., stripes, which may be visually distinguishable from the background graphic at any viewing distance of display device 104. In at least one example, the first set of graphic patterns may refer to multiple stripes disposed or displayed at a first spatial frequency that is greater than a threshold frequency and with a first contrast ratio that is greater than a threshold contrast ratio, so that the first graphic may be visible to both authorized user 102 and unauthorized viewer 112. Thus, the first graphic may exclude confidential information 110 and further, in at least one example, the first graphic may comprise letters, characters, and/or numbers, which are intentionally misleading to unauthorized viewer 112, e.g., wrong passwords. Spatial frequency may refer to the frequency that the graphic patterns change at a direction, e.g., the width of the stripes changes at the horizontal direction. Contrast ratio may refer to a ratio of the luminance of the brightest color to that of the darkest color of the graphic patterns, e.g., a ratio of the luminance of the bright stripes to the luminance of the dark stripes. The threshold frequency and the threshold contrast ratio may be determined in accordance with existing research with respect to human eyes and the predetermined viewing distance. For example, the first graphic may be visible to unauthorized viewer 112 ten meters away if the spatial frequency is greater than a threshold frequency, e.g., 1/0.01 mm, and the contrast ratio is greater than 1000:1.

Block 414 may further refer to secure image generator 208 replacing the non-overlapping portions of the image data associated with the second graphic with a second set of graphic patterns that are visually indistinguishable from the background graphic outside of the predetermined viewing distance of display device 104. The second set of graphic patterns may refer to multiple stripes at a second spatial frequency that is less than the threshold frequency and with a second contrast ratio that is less than the threshold contrast ratio so that the second graphic ay not visible to unauthorized viewer 112. The second graphic may comprise confidential information 110. In some examples, secure image generator 208 may be configured to replace the overlapping portions of the image data with a third set of graphic patterns at a third spatial frequency and in a third contrast ratio. The third spatial frequency may or may not be the same as either the first or the second spatial frequency and the third contrast ratio may or may not be the same as either the first or the second contrast ratio. In other examples, the third set of graphic patterns may refer to the combination of the first set and the second set of graphic patterns.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

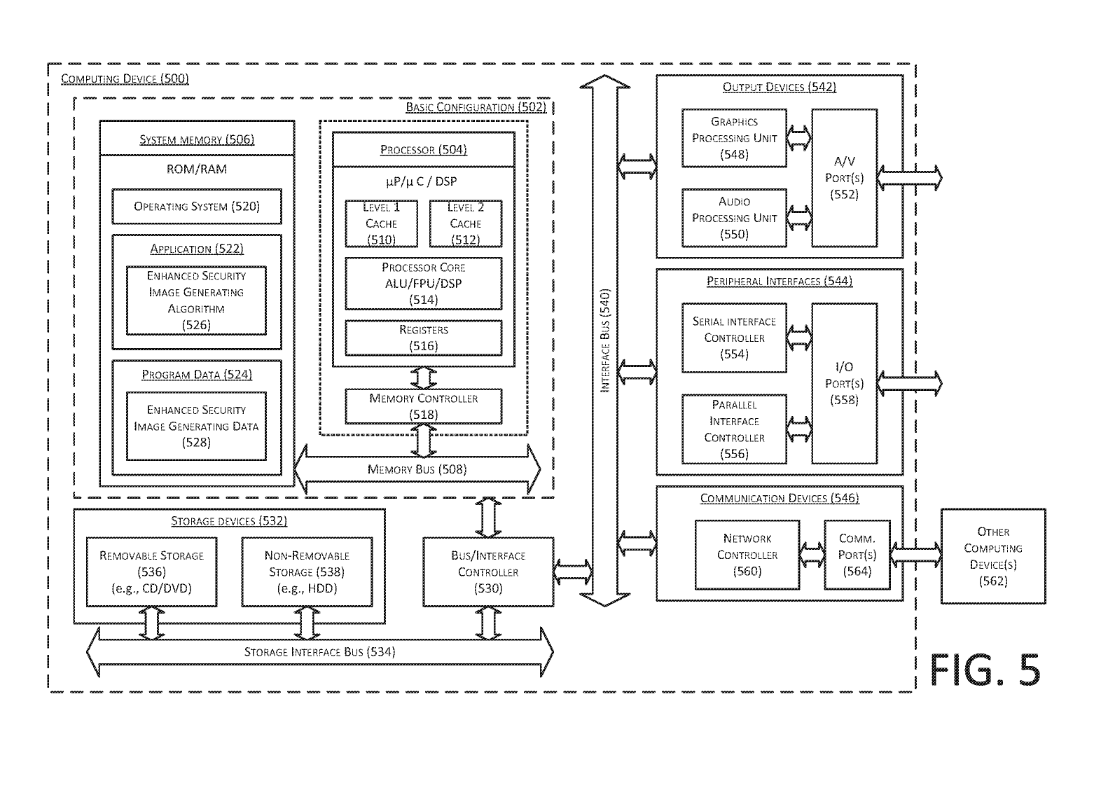

FIG. 5 shows a block diagram illustrating an example computing device that is arranged for secure image generating, arranged in accordance with at least some embodiments described herein In a very basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524. Application 522 may include a secure image generating algorithm 526 that is arranged to perform the functions as described herein including those described with respect to process 400 of FIG. 4. Program data 524 may include enhance security image generating data 528 that may be useful for operation with secure image generating algorithm 526 as is described herein. In some embodiments, application 522 may be arranged to operate with program data 524 on operating system 520 such that implementations of secure image generating may be provided as described herein. This described basic configuration 502 is illustrated in FIG. 5 by those components within the inner dashed line.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any s computer storage media may be part of computing device 500.

Computing device 500 may also include an interface bus 540 for facilitating communication from various interface device (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

In some examples, a method to enhance security of information displayed on a display device comprises providing information data (which may be image data, text data (e.g. alphanumeric data), or any information-conveying data. An information display of the information data is displayed on the display device to convey the information, the information display including an information graphic and a background, the information graphic being displayed against the background. The background may be a solid color, patterned color, image, graphic, and the like. The information graphic may include a first graphic portion and a second graphic portion. In some examples, the first graphic portion has a lower perceived contrast against the background than the second graphic portion. In some examples, the first graphic portion is displayed with a brightness modulation at a first spatial frequency, and the second graphic portion is displayed with a second brightness modulation at a second spatial frequency. As a result of the brightness modulation, a graphic portion may appear (when viewed at close range so that resolution is not an issue) as alternating bright and dark bands. In some examples, the bright and dark bands may be generally straight and parallel to each other, though in some examples the bands may be curved or otherwise presented. The first spatial frequency may be appreciated by different from the second spatial frequency, for example one spatial frequency may be greater than the other by a factor of, for example, 1.5, 2, 3, 5, or 10.

A graphic portion may have an average brightness (and/or color) that is similar to that of the background. Then, when a viewer is far enough away from the display that the viewer is no longer able to fully visually resolve the brightness (and/or other) modulation, the graphic portion will tend to blend into the background and may not be visually discernable against the background for greater than a predetermined viewing distance (e.g. for typical human vision).

in some examples, other spatial modulation may be used in addition to or alternative to brightness modulation, such as color modulation, polarization modulation, and the like. For example, a graphic portion having alternating bands of a first color and a second color will tend to blend into a background of the combination of the first and second colors beyond a certain viewing distance. For example, alternating yellow and blue bands may not be visually discernable against a green background beyond a certain viewing distance. In some examples, the background may have a background brightness, and a graphic portion may have a brightness modulation visually discernable within a certain viewing range, and may be perceived as a visually uniform element with an average brightness similar to the background brightness outside of a viewing range. In some examples, dots (such as pixels or multi-pixel elements), lines, and other shapes may be used to achieve modulation in one or more direction. For example, a graphic portion may be displayed using yellow and blue dots (or other shapes) against a green background. Spatial frequency may be a measure of dot repeat distance, or otherwise representative of a spatially modulated (e.g. in brightness and/or color) graphic portion. In some example, flicker frequency may be used as a basis of modulation.

In some examples, a first graphic portion is visually distinguishable from the background within a predetermined viewing distance of the display device; and a second graphic portion is visually indistinguishable from the background outside of the predetermined distance of the display device. For example, this may be achieved where the second spatial frequency is appreciably higher than the first spatial frequency.

In some examples, an information graphic includes one or more alphanumeric graphics. Displaying the information display may include displaying the information graphic as a plurality of graphic segments, including a first graphic segment and a second graphic segment. The first graphic portion may include one or more segments such as the first graphic segment, and the second graphic portion may include one or more other segments such as the second graphic segment. The first graphic segment may be displayed with a brightness modulation at a first spatial frequency, and the second graphic segment is displayed with a second brightness modulation at a second spatial frequency. At a close viewing distance, where first and second modulations may both be visually resolved, all segments may be perceived. From further away, one or both modulations may not be visually resolved, so that one or both segments may not be visually perceived.

In some examples, a method of presenting information includes (or a display may be configured to allow) presenting characters and images on an electronic display such that a viewed near the display may easily discern the characters or images, while a viewer further away cannot. Some examples include displaying one or more characters and/or images with certain portions (such as segments) having a brightness modulation (such as an in-fill hatch) at one spatial frequency and other segments having a brightness modulation at a second, different spatial frequency. For example, for the character 8 (eight), outer segments may be displayed with a lower spatial frequency modulation while the middle segment may be displayed with a high spatial frequency modulation. To those far away, the middle segment may appear grey since they are not able to visually resolve the modulation (e.g. hatch pattern), and thus those far away may confuse the character with a 0. Other characters can be similarly displayed, for example using segmented representations of alphanumeric character. In this way, displayed text (such as passwords) may be obfuscated to unwanted viewers. In some examples, the location of unwanted viewers may be determined from the mistakes made when the unwanted viewer tries to enter e.g. a password, for example by creating different visual obfuscations as a function of location.

In some examples, graphics (such as alphanumeric characters, symbols, and the like) may be displayed with first and second line thicknesses (e.g. as a mixture of bold and fine font, either varying between characters or within the same character). For example, the character 8 (eight, in seven segment representation) could be displayed with outer segments having a first line thickness and a middle segment having a second (narrower, in this example) line thickness. The character may appear as a 0 (zero, in seven segment representation) to eavesdroppers. In some examples, line segments may be displayed as hashed or dotted, having first and second spatial frequency and/or thickness.

In some examples, information that may be obfuscated using such apparatus and methods may include passwords, account information, financial data, security data, sensitive (e.g. personal) messages, or any text, graphic, symbol, image, and/or or other information representation. TA viewing range may be predetermined using parameters such as display and graphic size, spatial frequency, and the like. A viewing range may be determined for normal human vision, outstanding human vision, and/or augmented human vision, e.g. using magnifying optics.

The foregoing detailed description has net forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually, and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer system s one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “inc des but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at leas e recited number (e.g., the bare recitation of “two recitations,” without other modifiers, means at least two recitations, or two or more recitations) Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method to enhance security of information displayed on a display device, the method comprising:
providing an initial image file that includes first and second graphics superimposed over a background graphic, wherein the initial image file includes image data associated with non-overlapping portions of the first and second graphics; and
generating a secure image for display on the display device by:
identifying the non-overlapping portions of the image data, wherein the non-overlapping portions of the image data are associated with either the first graphic or the second graphic;
replacing the non-overlapping portions of the image data associated with the first graphic with a first set of graphic patterns that are visually distinguishable from the background graphic within a predetermined viewing distance of the display device; and
replacing the non-overlapping portions of the image data associated with the second graphic with a second set of graphic patterns that are visually indistinguishable from the background graphic outside of the predetermined distance of the display device.

2. The method of claim 1, wherein the generating comprises:
identifying overlapping portions of the image data associated with the first second graphics of the initial image file;
replacing the non-overlapping portions of the image data associated with the first graphics with the first set of graphic patterns at a first spatial frequency and with a first contrast ratio;
replacing the non-overlapping portions of the image data associated with the second graphics with the second set of graphic patterns at a second spatial frequency and with a second contrast ratio; and
replacing the overlapping portions of the image data with a third set of graphic patterns at a third spatial frequency and at a third contrast ratio.

3. The method of claim 1, further comprising displaying the secure image on the display device.

4. The method of claim 2, wherein the first spatial frequency is less than a threshold frequency and the first contrast ratio is less than a threshold contrast ratio.

5. The method of claim 2, wherein the second spatial frequency is greater than the threshold frequency and the second contrast ratio is greater than the threshold contrast level.

6. The method of claim 1, wherein the providing the initial image file comprises providing the first and second graphics in multiple forms including characters, letters, numbers, or symbols.

7. The method of claim 1, wherein the providing the initial image file comprises providing a security question, an input password, a login username, or private information.

8. The method of claim 2, wherein the replacing the overlapping portion of the image data with the third set of graphic patterns comprises generating the third spatial frequency that is equal to the second spatial frequency and the third contrast ratio that is equal to the second contrast ratio.

9. A system to enhance security of information displayed on a display device, the system comprising:
a cloud based server configured to:
generate image data associated with an initial image file that includes first and second graphics superimposed over a background graphic, wherein the image data includes non-overlapping portions of the first and second graphics, and transmit the image data via a network; and
a display controller configured to:
detect a secured environment,
receive the image data associated with the initial image file via the network, and
generate a secure image for display on the display device by:
identifying the non-overlapping portions of the image data, wherein the non-overlapping portions of the image data are associated with either the first graphic or the second graphic,
replacing the non-overlapping portion of the image data associated with the first graphic with a first set of graphic patterns that are visually distinguishable from the background graphic within a predetermined viewing distance of the display device, and
replacing the non-overlapping portions of the image data associated with the second graphic with a second set of graphic patterns that are visually indistinguishable from the background graphic outside of the predetermined distance of the display device.

10. The system of claim 9, wherein the display controller is further configured to:
identify overlapping portions of the image data associated with the first second graphics of the initial image file;
replace the non-overlapping portions of the image data associated with the first graphics with the first set of graphic patterns at a first spatial frequency and with a first contrast ratio;
replace the non-overlapping portions of the image data associated with the second graphics with the second set of graphic patterns at a second spatial frequency and with a second contrast ratio; and
replace the overlapping portions with a third set of graphic patterns in a third spatial frequency and in a third contrast ratio.

11. The system of claim 9, wherein the display controller is further configured to display the on the display device.

12. The system of claim 9, wherein the first spatial frequency is greater than a threshold frequency and the first contrast ratio is greater than a threshold contrast.

13. The system of claim 9, wherein the second spatial frequency is less than the threshold frequency and the second contrast ratio is less than the threshold contrast.

14. The system of claim 9, wherein the initial image includes at least one of character, letter, number, or symbol to indicate a security question, an input password, a login username, or private information.

15. The system of claim 10, wherein the third spatial frequency is equal to the second spatial frequency and the third contrast ratio is equal to the second contrast ration.

16. A computer-readable medium that stores executable-instructions that, when executed, cause one or more processors to perform operations comprising:
providing an initial image file that includes first and second graphics superimposed on a background graphic, wherein the initial image file includes image data associated with non-overlapping portions of the first and second graphics; and
generating a secure image for display on the display device by:
identifying the non-overlapping portions of the image data, wherein the non-overlapping portions of the image data are associated with either the first graphics or the second graphics,
identifying overlapping portions of the first and second graphics,
replacing the non-overlapping portions of the image data associated with the first graphics with a first set of graphic patterns that are visually distinguishable from the background graphic within a predetermined viewing distance of the display device,
replacing the non-overlapping portions of the image data associated with the second graphics with a second set of graphic patterns that are virtually indistinguishable from the background graphic outside of the predetermined viewing distance of the display device, and
replacing the overlapping portions of the image data with a third set of graphic patterns.

17. The computer-readable medium of claim 16, wherein the first set of graphic patterns are displayed at a first spatial frequency and with a first contrast ratio, the second set of graphic patterns are displayed at a second spatial frequency and with a second contrast ratio, and the third set of graphic patterns are displayed at a third spatial frequency and with a third contrast ratio.

18. The computer-readable medium of claim 16, further comprising displaying the secure image on the display device.

19. The computer-readable medium of claim 17, wherein the first spatial frequency is greater than a threshold frequency and the first contrast ratio is greater than a threshold contrast.

20. The computer-readable medium of claim 17, wherein the second spatial frequency is less than the threshold frequency and the second contrast ratio is less than the threshold contrast.

21. The computer-readable medium of claim 17, wherein the third spatial frequency is equal to the second spatial frequency and the third contrast ratio is equal to the second contrast ratio.

22. The computer-readable medium of claim 17, wherein the third graphic patterns are a combination of the first graphic patterns and the second graphic patterns.

23. A method to enhance security of information displayed on a display device, the method comprising:
providing information data; and
displaying an information display of the information data on the display device to convey the information, the information display including an information graphic and a background, the information graphic being displayed against the background,
wherein the information graphic includes a first graphic portion and a second graphic portion,
the first graphic portion is visually distinguishable from the background within a predetermined viewing distance of the display device, the first graphic portion having a lower perceived contrast against the background than the second graphic portion, and
the second graphic portion is visually indistinguishable from the background outside of the predetermined distance of the display device.

24. The method of claim 23, wherein providing the information data includes providing an initial image file.

25. The method of claim 23, wherein providing the information data includes providing alphanumeric data.

26. The method of claim 23, further including displaying the first graphic portion with a brightness modulation at a first spatial frequency,
displaying the second graphic portion with a second brightness modulation at a second spatial frequency,
the first spatial frequency being different from the second spatial frequency.

27. (canceled)

28. The method of claim 23, wherein displaying the information display including the information graphic includes displaying an alphanumeric graphic as the information graphic.

29. The method of claim 23, wherein displaying the information display including the information graphic includes displaying the information graphic as a plurality of graphic segments including a first graphic segment and a second graphic segment, wherein
the first graphic portion includes the first graphic segment,
the second graphic portion includes the second graphic segment.
